(19) United States
(12) Patent Application Publication
(10) Pub. No.: US 2026/0177064 A1
(43) Pub. Date: Jun. 25, 2026

(54) INFLATABLE OUTDOOR DECORATION APPARATUS

(71) Applicant: East Coast IP, LLC, Raleigh, NC (US)

(72) Inventor: Russell Speight VanBlon, Raleigh, NC (US)

(21) Appl. No.: 18/990,299

(22) Filed: Dec. 20, 2024

(51) Int. Cl. F04D 27/00; G09F 19/00

(52) U.S. Cl. CPC F04D 27/00; G09F 19/008

(57) ABSTRACT

In one aspect, an inflatable outdoor decoration apparatus may include a sensor that is used to determine whether to deflate the inflatable outdoor decoration itself in response to wind gusts, preventing the inflatable outdoor decoration from becoming damaged or blowing away.

### FIELD

The disclosure below relates to technically inventive, non-routine solutions that are necessarily rooted in computer technology and that produce concrete technical improvements. In particular, the disclosure below relates to inflatable outdoor decoration apparatuses.

### BACKGROUND

People sometimes put inflatable yard decorations in their yard for holidays such as Halloween, Thanksgiving, and Christmas. These yard decorations typically come with strings and anchors to anchor the decoration to the ground. But as recognized herein, when a strong wind comes along, those anchors might not be strong enough to withstand the wind. Even if the anchors hold, the attached string might tear away from the yard decoration due to the force of the wind and thereby damage the decoration anyway. As also recognized herein, there may be situations where anchors cannot be used at all, meaning the inflatable decoration is even more vulnerable to the wind. No adequate solutions currently exist to the foregoing problems.

### SUMMARY

Accordingly, in one aspect an inflatable outdoor decoration apparatus includes an inflatable outdoor decoration, a fan to inflate the inflatable outdoor decoration, a processor system, a sensor accessible to the processor system, and storage accessible to the processor system. The storage includes instructions executable by the processor system to, while the inflatable outdoor decoration is inflated via the fan, receive input from the sensor. The instructions are also executable to use the input from the sensor to determine whether a threshold is met, and to control the fan to deflate the inflatable outdoor decoration responsive to determining that the threshold is met.

In various example implementations, the instructions may be executable to control the fan to deflate the inflatable outdoor decoration by reducing a duty cycle of the fan and/or turning the fan off.

In one example embodiment, the sensor may include a wind speed sensor and the threshold may be a wind speed threshold. Here, the instructions may be executable to use the input from the wind speed sensor to determine whether the wind speed threshold is met, and then to control the fan to deflate the inflatable outdoor decoration responsive to determining that the wind speed threshold is met.

Also in one example embodiment, the sensor may include a motion sensor and the threshold may be a movement threshold. Here, the instructions may be executable to use the input from the motion sensor to determine whether the movement threshold is met, and then to control the fan to deflate the inflatable outdoor decoration responsive to determining that the movement threshold is met. In various example instances, the movement threshold may be a movement amount threshold, such as an angular movement amount threshold and/or an acceleration amount threshold.

Additionally, if desired the instructions may be executable to control the fan to continue to maintain the inflatable outdoor decoration in an inflated state responsive to determining that the threshold is not met.

In another aspect, a method includes receiving input from a sensor on an inflatable outdoor decoration apparatus and then using the input from the sensor to determine that a threshold is met. The method then includes, responsive to determining that the threshold is met, controlling a fan of the inflatable outdoor decoration apparatus to deflate an inflatable outdoor decoration of the inflatable outdoor decoration apparatus.

In various examples, the method may include controlling the fan to deflate the inflatable outdoor decoration by reducing a duty cycle of the fan and/or by turning the fan off.

Also in various examples, the sensor may include a wind speed sensor and the threshold may be a wind speed threshold. Here, the method may include using the input from the wind speed sensor to determine that the wind speed threshold is met, and then controlling the fan to deflate the inflatable outdoor decoration responsive to determining that the wind speed threshold is met.

Additionally or alternatively, the sensor may include a motion sensor and the threshold may be a movement threshold. Here the method may include using the input from the motion sensor to determine that the movement threshold is met, and then controlling the fan to deflate the inflatable outdoor decoration responsive to determining that the movement threshold is met.

In still another aspect, an apparatus includes at least one computer readable storage medium (CRSM) that is not a transitory signal. The at least one CRSM includes instructions executable by a processor system to receive input from a sensor and use the input from the sensor to determine that a threshold is met. The instructions are also executable to, responsive to determining that the threshold is met, control a fan to deflate an inflatable outdoor decoration.

In one example embodiment, the sensor may include a wind speed sensor and the threshold may be a wind speed threshold. Here, the instructions may be executable to use the input from the wind speed sensor to determine that the wind speed threshold is met. The instructions may also be executable to, responsive to determining that the wind speed threshold is met, control the fan to deflate the inflatable outdoor decoration.

Also in an example embodiment, the sensor may include a motion sensor and the threshold may be a movement threshold. Here, the instructions may be executable to use the input from the motion sensor to determine that the movement threshold is met. The instructions may also be executable to, responsive to determining that the movement threshold is met, control the fan to deflate the inflatable outdoor decoration.

Also, if desired the apparatus may include the processor system, the sensor, the fan, and/or the inflatable outdoor decoration.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example computing system consistent with present principles;

FIG. 2 is a perspective view of an example outdoor decoration apparatus consistent with present principles; and

FIG. 3 illustrates example logic in example flow chart format that may be executed by an apparatus consistent with present principles.

### DETAILED DESCRIPTION

This disclosure relates generally to aspects of consumer electronics (CE) devices and other types of client devices and servers. Thus, devices herein may include server and client components which may be connected over a network such that data may be exchanged between the client and server components. The client components may include one or more computing devices including mobile smart phones and other mobile devices, wearable devices, game consoles, extended reality (XR) headsets such as virtual reality (VR) headsets and augmented reality (AR) headsets, display devices such as televisions (e.g., smart TVs, Internet-enabled TVs), personal computers such as laptops, desktop, and tablet computers, and still other types of devices. These client devices may operate with a variety of operating environments. For example, a client device consistent with present principles may employ, as examples, Linux and Unix operating systems, operating systems from Microsoft, or operating systems from Apple or Google. These operating environments may be used to execute one or more browsing programs, such as a browser made by Microsoft, Apple, Google, or Mozilla. The operating environments may also be used to execute other Internet-networked dedicated mobile applications that can access websites hosted by the Internet servers over a network such as the Internet, a local intranet, or a virtual private network.

Servers and/or gateways may be used that may include one or more processors executing instructions that configure the servers to receive and transmit data over a network such as the Internet. Or a client and server can be connected over a local intranet or a virtual private network. A server or controller may be instantiated by a personal computer, mobile device, rack or blade server, etc.

As indicated above, information may be exchanged over a network between client devices and servers. To this end and for security, servers and/or clients can include firewalls, load balancers, temporary storages, and proxies, and other network infrastructure for reliability and security.

As used herein, instructions may refer to computer-implemented steps for processing information in the system. Instructions can be implemented in software, firmware or hardware, or combinations thereof and include any type of programmed steps undertaken by components of the system.

A processor may be any single- or multi-chip processor that can execute logic by means of various lines such as address lines, data lines, and control lines and registers and shift registers. Moreover, any logical blocks, modules, and circuits described below can be implemented or performed with a processor/processor system such as a central processing unit (CPU), a digital signal processor (DSP), a field programmable gate array (FPGA) or other programmable logic device, an application specific integrated circuit (ASIC), discrete gate or transistor logic, discrete hardware components, or any combination thereof designed to perform the functions described herein. A processor can be implemented by a controller or state machine or a combination of computing devices.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

The functions and methods described below, when implemented in software, can be written in an appropriate language such as but not limited to hypertext markup language (HTML)-5, Java®/Javascript, C# or C++, and can be stored on or transmitted from a computer-readable storage medium such as a hard disk drive (HDD) or solid state drive (SSD), random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

In an example, a processor system can access information over its input lines from data storage, such as a computer readable storage medium as referenced above, and/or the processor system can access information wirelessly from an Internet server by activating a wireless transceiver to send and receive data. Data typically is converted from analog signals to digital by circuitry between the antenna and the registers of the processor system when being received and from digital to analog when being transmitted. The processor system then processes the data through its shift registers to output calculated data on output lines, for presentation of the calculated data on the device, etc.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

Note that present principles may also employ machine learning models, including deep learning models. Machine learning models use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as one or more convolutional neural networks (CNNs) and/or one or more recurrent neural networks (RNNs) (such as a type of RNN known as a long short-term memory (LSTM) network). Support vector machines (SVM) and Bayesian networks also may be considered to be examples of machine learning models.

As understood herein, performing machine learning involves accessing and then training a model on training data to enable the model to process further data to make predictions. A neural network may include an input layer, an output layer, and multiple hidden layers in between that are configured and weighted to make inferences about an appropriate output.

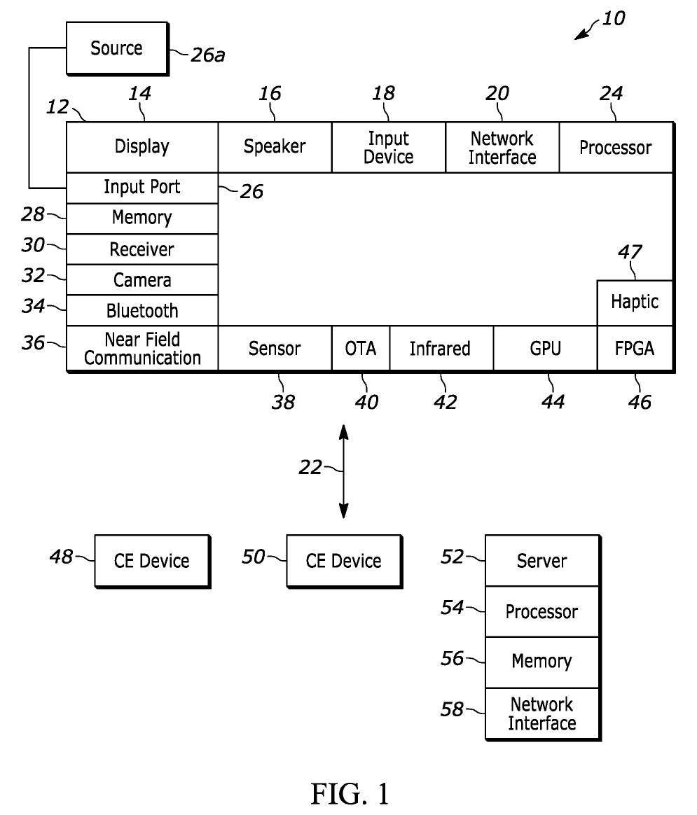

Referring now to FIG. 1, an example system 10 is shown, which may include one or more of the example devices mentioned above and described further below in accordance with present principles. The first of the example devices included in the system 10 is a consumer electronics (CE) device 12. The CE device 12 may be a computerized Internet enabled (“smart”) phone, a tablet computer, a laptop/notebook computer, a desktop computer, a head-mounted device (HMD) and/or headset such as smart glasses or AR or VR headset, another wearable computerized device, etc. Regardless, it is to be understood that the CE device 12 is configured to undertake present principles (e.g., communicate with other CE devices and servers to undertake present principles, execute the logic described herein, and perform other functions and/or operations described herein).

Accordingly, to undertake such principles the CE device 12 can be established by some, or all, of the components shown. For example, the CE device 12 can include one or more touch-enabled displays 14 that may be implemented by a high definition or ultra-high definition “4K” or higher flat screens. The touch-enabled display(s) 14 may include, for example, a capacitive or resistive touch sensing layer with a grid of electrodes for touch sensing consistent with present principles (e.g., to provide input to the GUIs discussed below).

The CE device 12 may also include an analog audio output port 15 to drive one or more external speakers or headphones, and may include one or more internal speakers 16 for outputting audio in accordance with present principles, and at least one additional input device 18 such as an audio receiver/microphone, e.g., for conversing telephonically or for entering audible commands to the CE device 12 to control the CE device 12. The example CE device 12 may also include one or more wired or wireless network interfaces 20 for communication over at least one network 22 such as the Internet, a WAN, a LAN, etc. under control of one or more processors of a processor system 24, such as a CPU or other processor mentioned above. Thus, the interface 20 may be, without limitation, a Wi-Fi transceiver and/or wireless telephony transceiver for communicating over a wireless cellular network (e.g., operated by Verizon, T-Mobile, or AT&T), both of which are examples of a wireless computer network interface.

It is to be understood that the processor system 24 may include one or more processors acting independently or in concert with each other to execute an algorithm (e.g., the algorithms referenced herein), whether those processors are in one device or more than one device. Thus, in some specific examples, the processor system may include a single processor, while in other examples the processor system may include more than one processor. The processor system 24 controls the CE device 12 to undertake present principles, including the other elements of the CE device 12 described herein such as controlling the display 14 to present images thereon and receiving input therefrom. Furthermore, also note the network interface 20 may be a wired or wireless modem or router or other suitable network interface.

In addition to the foregoing, the CE device 12 may also include one or more input and/or output ports 26 such as a high-definition multimedia interface (HDMI) port or a universal serial bus (USB) port to physically connect to another CE device, and/or a headphone port to connect headphones to the CE device 12 for presentation of audio from the CE device 12 to a user through the headphones. For example, the input port 26 may be connected wired or wirelessly to a cable or satellite source 26a of audio video content. Thus, the source 26a may be a separate or integrated set top box, or a satellite receiver. Or the source 26a may be a game console or disk player containing content.

The CE device 12 may further include one or more non-transitory computer memories/computer-readable storage media 28 such as disk-based or solid-state storage that are not transitory signals, in some cases embodied in the chassis/housing of the CE device 12 (e.g., as standalone devices) or as removable memory media or the below-described server(s). Also, in some embodiments, the CE device 12 can include a position or location receiver such as but not limited to a cell phone transceiver, global positioning system (GPS) transceiver, and/or altimeter 30. This transceiver may therefore be configured to receive geographic position information from a satellite or cellphone base station (and/or determine an altitude at which the CE device 12 is disposed) and then provide the information to the processor system 24. However, it is to be understood that another suitable position receiver other than a GPS receiver, cell phone transceiver, and/or altimeter may be used consistent with present principles to determine the location of the CE device 12. In some examples, the GPS transceiver 30 may be located on a streetlight or other infrastructure for which location is to be reported for purposes described in greater detail below.

Continuing the description of the CE device 12, in some embodiments the CE device 12 may include one or more cameras 32 that may be thermal imaging cameras, digital cameras such as webcams, infrared (IR) sensors, and/or other types of cameras or other optical sensors integrated into the CE device 12 and controllable by the processor system 24 to gather pictures/images and/or video consistent with present principles. Also included on the CE device 12 may be a Bluetooth^{®} transceiver 34 and/or other Near Field Communication (NFC) element 36 for communication with other devices using respective Bluetooth and/or NFC wireless technologies/communication standards. An example NFC element can be a radio frequency identification (RFID) element.

Further still, the CE device 12 may include one or more auxiliary sensors 38 that provide input to the processor system 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc.

Other sensor examples include a motion sensor such as an accelerometer, gyroscope, magnetometer, a speed and/or cadence sensor, an event-based sensor, a gesture sensor (e.g., for sensing gesture command), etc. In one specific example, the sensor 38 thus may be implemented as an inertial measurement unit (IMU) with motion sensors including individual accelerometers, gyroscopes, and magnetometers, and/or other components of that include a combination of accelerometers, gyroscopes, and magnetometers, to determine the location and orientation of the CE device 12 in three dimensions. A gyroscope consistent with present principles may sense and/or measure the orientation of the CE device 12 and provide related input to the processor system 24, an accelerometer consistent with present principles may sense acceleration and/or movement of the CE device 12 and provide related input to the processor system 24, and a magnetometer consistent with present principles may sense and/or measure directional movement of the CE device 12 and provide related input to the processor 122.

The CE device 12 may also include an over-the-air TV broadcast port 40 for receiving OTA TV broadcasts and providing the input to the processor system 24. In addition to the foregoing, it is noted that the CE device 12 may also include an IR transceiver 42 such as an IR data association (IRDA) device. A battery (not shown) may be provided for powering the CE device 12, as may a kinetic energy harvester that may turn kinetic energy into power to charge the battery and/or power the CE device 12. A graphics processing unit (GPU) 44 and field programmable gated array 46 also may be included.

One or more haptics/vibration generators 47 may also be provided for generating tactile signals/vibrations that can be sensed by a person holding or in contact with the device. The haptics generators 47 may thus vibrate all or part of the CE device 12 using an electric motor connected to an off-center and/or off-balanced weight via the motor’s rotatable shaft so that the shaft may rotate under control of the motor (which in turn may be controlled by a processor such as the processor system 24) to create vibration of various frequencies and/or amplitudes as well as force simulations in various directions.

In addition to the CE device 12, the system 10 may include one or more other CE devices/types, which may include some or all of the components mentioned above in relation to the CE device 12. In one example, a second CE device 48 may be established by an Internet of things (IoT) device, a smartphone, a laptop computer, etc. A third CE device 50 is also shown in FIG. 1 and may include similar components as the other CE devices. Thus, in one example, the CE device 50 may be configured as a head-mounted display (HMD) that may include a heads-up transparent or non-transparent display for respectively presenting extended reality (XR) content such as AR content, VR, content, and/or mixed reality (MR) content. The XR content itself might include, as an example, one or more of the GUIs described below, presented stereoscopically. The HMD may be configured as a glasses-type display, or as goggle-type and/or VR-type display vended by various computer hardware manufacturers such as Apple, Oculus, Meta, etc. Or the CE device 50 may be established by a smart streetlight consistent with present principles and, as such, the smart streetlight may include a network communication interface (e.g., Wi-Fi transceiver and/or cellular data transceiver) for communicating with other devices to implement present principles.

In the example shown, only three CE devices are shown, it being understood that fewer or more devices may be used. A device herein may implement some or all of the components shown for the CE device 12. Any of the components shown in the following figures may incorporate some or all of the components shown in the case of the CE device 12.

Now in reference to the afore-mentioned at least one server 52, it includes at least one server processor 54 and at least one tangible computer readable storage medium 56 such as disk-based or solid-state storage. The server 52 also includes at least one network interface 58 that, under control of the server processor 54, allows for communication with other illustrated devices over the network 22 (e.g., the Internet), and indeed may facilitate communication between the server 52 and any other servers/client devices as described herein. Note that the network interface 58 may be, e.g., a wired or wireless modem or router, Wi-Fi or Ethernet transceiver, or other appropriate interface such as, e.g., a wireless telephony transceiver.

Accordingly, in some embodiments the server 52 may be an Internet server or an entire server “farm” of multiple services. If desired, the server 52 may include/perform “cloud” functions such that the devices of the system 10 may access a “cloud” environment via the server 52 in certain example embodiments. Additionally or alternatively, the server 52 may be implemented by one or more computers in the same room as the other devices shown, or nearby.

The components shown in the following figures may include some or all components shown herein.

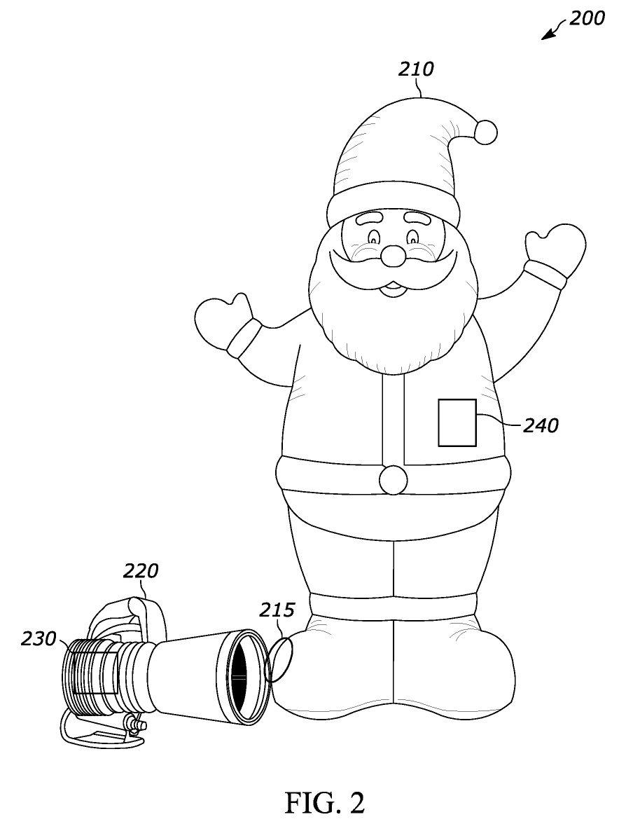

Now in reference to FIG. 2, an inflatable outdoor decoration apparatus 200 is shown. The apparatus 200 may include an inflatable outdoor decoration 210 that is made of cloth, a polymer such as nylon, and/or other suitable material. In the present example, the decoration 210 is a Santa figure, though the decoration might also be a pumpkin, turkey, Easter bunny, or other figure. The decoration 210 may be enclosed to create an air cavity inside when inflated (or partially enclosed with perforations for air to escape in small amounts), save for an opening 215 through which the nozzle or other front portion of a fan 220 may be positioned for the fan 220 to push air into the decoration 210 to inflate the decoration 210 as shown in FIG. 2. Note that in some specific instances, the fan 220 may be established by a blower or other concentrated air movement device.

Also note that while the fan 220 is shown adjacent to the decoration 210 while both sit on the ground, the fan 220 might alternatively sit inside the bottom of the decoration 210 itself to direct air upward within the decoration 210 to inflate the decoration 210. Other locations of the fan 220 relative to the decoration 210 are also encompassed by present principles.

Note further that the fan 220 may be connected to an alternating current (AC) or direct current (DC) power source, such as a wall outlet or battery. The fan 220 may therefore be turned on to drive a motor in the fan 220 to rotate blades of the fan 220 to drive air into the decoration 210. The fan 220 may therefore include a physical on/off switch to turn the fan on to drive the air and off to stop driving the air.

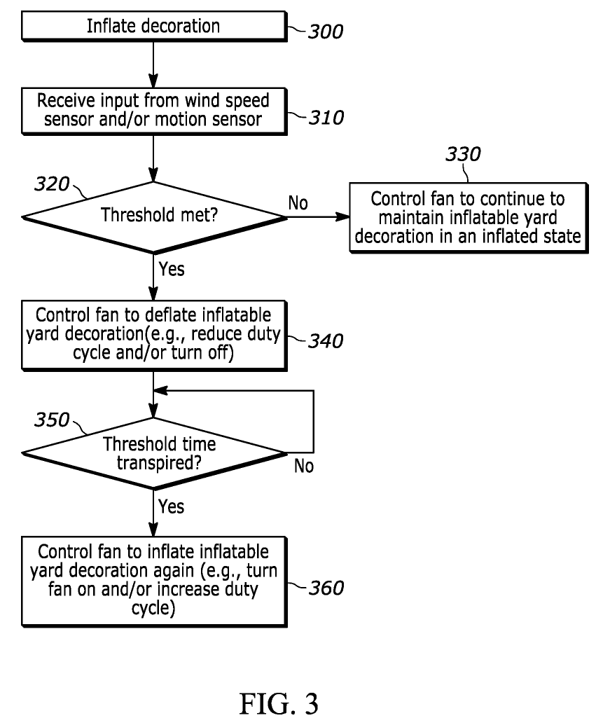

The fan 220 may also include a computing system 230, which might include some or all components of the CE device 12 described above. The system 230 may be connected to the fan 220 to also control the fan 220 using the system 230 consistent with present principles. The computing system 230 may therefore include a processor system and storage with instructions executable by the processor system. The system 230 may thus be used to turn the fan 220 on and off consistent with the logic of FIG. 3, as will be discussed later.

FIG. 2 also shows that mounted onto the decoration 210 may be a sensor 240 that is accessible to the processor system inside the computing system 230, either through a wired connection or wireless connection (e.g., Bluetooth or Wi-Fi) between the sensor 240 and the system 230. The sensor 240 may include a wind speed sensor such as, but not limited to, an ultrasonic wind speed sensor or a mechanical wind speed sensor. Additionally or alternatively, the sensor 240 may include a motion sensor such as a gyroscope and/or accelerometer (e.g., as embodied in an inertial measurement unit (IMU) establishing the sensor 240). Other sensor types may also be used consistent with present principles.

It is to be further understood that the position of the sensor 240 on the decoration 210 as shown in FIG. 2 is an example, and that the sensor 240 may be disposed at other locations on the apparatus 200 as well. For example, in embodiments where the sensor 240 includes a wind speed sensor, the wind speed sensor might be located on the fan 220 or even a decoration base (not shown) that is attached to the bottom of the decoration 210. If a motion sensor is used, in certain non-limiting examples it may be advantageous to mount the sensor 240 to the decoration 210 itself (or its base) since the decoration is more likely to blow in the wind (and thus be damaged or blow away) than the relatively heavier fan 220 that might not undergo as much movement in the wind and therefore not be an acceptable indicator. However, there are but examples.

Before moving on to FIG. 3, also note with respect to FIG. 2 that although the system 230 is shown as being disposed on the fan 220, it too may be disposed on the decoration 210 or another portion of the apparatus 200. For example, the system 230 and sensor 240 may be embodied together as its own hardware module (more generally, apparatus) mounted on the decoration 210, with it being further noted that the system 230 may still be in communication with the fan 220 either through a wired or wireless connection to nonetheless control the fan 220 even if located on the decoration 210 (or base).

Now in reference to FIG. 3, this figure shows example logic that may be executed by the processor system in the computing system 230 of FIG. 2. Or the logic might be executed by a smartphone application (“app”) that wirelessly receives input from the sensor 240 and wirelessly controls the fan 220 according to the logic set forth below through a wireless connection such as a Bluetooth or Wi-Fi connection. Further note that while the logic of FIG. 3 is shown in flow chart format, other suitable logic may also be used.

Beginning at block 300, the apparatus may inflate the decoration 210 by turning the fan 220 on, either responsive to the fan’s switch being switched to the on position and/or responsive the system 230 itself commanding the fan 220 to turn on. From block 310 the logic may then proceed to block 320.

At block 320, while the inflatable outdoor decoration is inflated via the fan, the apparatus may receive input from the sensor. Again note that the sensor may be a wind sensor, a motion sensor such as a gyroscope or accelerometer, or another type of sensor. The logic may then proceed to decision diamond 320.

At diamond 320 the apparatus may use the input from the sensor to determine whether a threshold is met. Responsive to determining that the threshold is not met, the logic may proceed to block 330 where the apparatus may control the fan to continue to maintain the inflatable outdoor decoration in its inflated state. However, responsive to determining that the threshold is met, the logic may instead proceed to block 340 where the apparatus may control the fan to partially or fully deflate the inflatable outdoor decoration.

Accordingly, at block 340 the apparatus may control the fan to deflate the inflatable outdoor decoration by reducing the duty cycle of the fan from a first non-zero percentage to a second non-zero percentage lower than the first non-zero percentage to cause the fan to go from operating at a first non-zero speed to a second (slower) non-zero speed, thereby deflating the decoration partially or fully. Additionally or alternatively but still at block 340, the apparatus may control the fan to deflate the inflatable outdoor decoration by turning the fan off, deflating the decoration fully.

In one particular instance, the apparatus may control the fan to gradually (e.g., incrementally) reduce its duty cycle from the first non-zero percentage to progressively lower non-zero percentages before turning the fan off completely. This may be done to prevent a kiting or parachute effect where the material of the decoration might still be momentarily floating up in the air but the decoration is more or less deflated and then a strong wind comes along to catch the decoration, potentially damaging the decoration or blowing it away.

Still in reference to FIG. 3, it may be appreciated that in one particular example according to the logic set forth above, the sensor may be a wind speed sensor and the threshold of diamond 320 may be a wind speed threshold. Here, the apparatus may use the input from the wind speed sensor to determine, at diamond 320, whether current wind speed as indicated in the input from the sensor meets the wind speed threshold. Responsive to determining that the wind speed threshold is met, the apparatus may then control the fan to deflate the inflatable outdoor decoration at block 340.

It may also be appreciated that in one example where the sensor is a motion sensor, the threshold of diamond 320 may be a movement threshold. Here, the apparatus may use the input from the motion sensor to determine, at diamond 320, whether current movement of the device as indicated in the input from the senor meets the movement threshold. Responsive to determining that the movement threshold is met, the apparatus may then control the fan to deflate the inflatable outdoor decoration at block 340.

What’s more, in one specific implementation where the motion sensor is an accelerometer in particular, the movement threshold may be an acceleration/movement amount threshold such that current movement (e.g., acceleration) indicated in the input from the accelerometer being above the threshold may result in an affirmative determination at diamond 320.

In another specific implementation where the sensor is a gyroscope, the movement threshold may be an angular movement amount threshold such that current angular movement indicated in the input from the gyroscope being above the threshold may result in an affirmative determination at diamond 320. In some specific cases, the threshold might specifically require a threshold amount of angular movement within a threshold, relatively short most-recent amount of time, allowing the apparatus to infer dramatically increasing wind impinging on the decoration (which is more-likely to cause damage).

Still in reference to FIG. 3, from block 340 the logic may then continue to decision diamond 350. At diamond 350 the apparatus may determine whether a threshold time has transpired from when the fan had its duty cycle reduced and/or was turned off. An affirmative determination at diamond 350 may cause the logic to proceed to block 360, while a negative determination at diamond 350 may cause the logic to continue making the same determination at diamond 350 until an affirmative determination is made (e.g., the threshold amount of time has transpired).

At block 360 the apparatus may then control the fan to reinflate the decoration again, such as by turning the fan back on and/or incrementally increasing the fan’s duty cycle back to the first non-zero percentage from a lower non-zero percentage. The logic may then return to block 310 to operate in a loop, with it being further noted that the logic may also return to block 310 from block 330.

In addition to or in lieu of the foregoing example involving a threshold amount of time transpiring, further note that the apparatus may receive additional input from the sensor after executing block 340 to then, at diamond 350, determine whether the second (subsequent) input from the sensor indicates current wind speed and/or current decoration movement that does not meet the threshold. Responsive to determining that the current speed and/or movement now does not meet the threshold, the apparatus may execute block 360 to reinflate the decoration.

In either case, it may be appreciated that an example lawn decoration apparatus as discussed herein may dynamically deflate during gusts or periods of wind, and then autonomously reinflate when conditions allow.

Additionally, in one particular example, multiple thresholds of the relevant type may be used such that increasing wind speeds and/or increasing decoration movements that go above progressively higher (incremental) thresholds may result in incrementally decreasing inflation of the decoration. Conversely, decreasing wind speeds and/or decreasing decoration movements that progressively go back below the different incremental thresholds may result in incrementally increasing inflation of the decoration. In this way, the decoration may still stay as inflated as possible in proportion to the wind speed and/or decoration movement itself.

In one particular aspect, an apparatus and method consistent with present principles may operate substantially as shown and described above, but may also be claimed as including some but not all aspects in any intermediate claim approach.

Before concluding, it is to be understood that although a software application for undertaking present principles may be vended with a device, present principles apply in instances where such an application is downloaded from a server to a device over a network such as the Internet. Furthermore, present principles apply in instances where such an application is included on a computer readable storage medium that is vended and/or provided by itself (e.g., apart from the inflatable decoration and fan itself), where the computer readable storage medium is not a transitory signal and/or a signal per se.

It may now be appreciated that present principles provide, among other technical improvements, improved computer-based user interfaces that increase the functionality and ease of use of the devices disclosed herein. The disclosed concepts are rooted in computer technology for computers to carry out their functions.

It is to be understood that whilst present principles have been described with reference to some example embodiments, these are not intended to be limiting, and that various alternative arrangements may be used to implement the subject matter claimed herein.

What is claimed is:

1. An inflatable outdoor decoration apparatus, comprising:
an inflatable outdoor decoration;
a fan to inflate the inflatable outdoor decoration;
a processor system;
a sensor accessible to the processor system; and
storage accessible to the processor system and comprising instructions executable by the processor system to:
while the inflatable outdoor decoration is inflated via the fan, receive input from the sensor;
use the input from the sensor to determine whether a threshold is met; and
responsive to determining that the threshold is met, control the fan to deflate the inflatable outdoor decoration.

2. The inflatable outdoor decoration apparatus of claim 1, wherein the instructions are executable to:
control the fan to deflate the inflatable outdoor decoration by turning the fan off.

3. The inflatable outdoor decoration apparatus of claim 1, wherein the instructions are executable to:
control the fan to deflate the inflatable outdoor decoration by reducing a duty cycle of the fan.

4. The inflatable outdoor decoration apparatus of claim 1, wherein the sensor comprises a wind speed sensor.

5. The inflatable outdoor decoration apparatus of claim 4, wherein the threshold is a wind speed threshold, and wherein the instructions are executable to:
use the input from the wind speed sensor to determine whether the wind speed threshold is met; and
responsive to determining that the wind speed threshold is met, control the fan to deflate the inflatable outdoor decoration.

6. The inflatable outdoor decoration apparatus of claim 1, wherein the sensor comprises a motion sensor.

7. The inflatable outdoor decoration apparatus of claim 6, wherein the threshold is a movement threshold, and wherein the instructions are executable to:
use the input from the motion sensor to determine whether the movement threshold is met; and
responsive to determining that the movement threshold is met, control the fan to deflate the inflatable outdoor decoration.

8. The inflatable outdoor decoration apparatus of claim 7, wherein the movement threshold is a movement amount threshold.

9. The inflatable outdoor decoration apparatus of claim 8, wherein the movement amount threshold is an angular movement amount threshold.

10. The inflatable outdoor decoration apparatus of claim 8, wherein the movement amount threshold is an acceleration amount threshold.

11. The inflatable outdoor decoration apparatus of claim 1, wherein the instructions are executable to:
responsive to determining that the threshold is not met, control the fan to continue to maintain the inflatable outdoor decoration in an inflated state.

12. A method, comprising:
receiving input from a sensor on an inflatable outdoor decoration apparatus;
using the input from the sensor to determine that a threshold is met; and
responsive to determining that the threshold is met, controlling a fan of the inflatable outdoor decoration apparatus to deflate an inflatable outdoor decoration of the inflatable outdoor decoration apparatus.

13. The method of claim 12, comprising one or more of:
controlling the fan to deflate the inflatable outdoor decoration by reducing a duty cycle of the fan; and/or
controlling the fan to deflate the inflatable outdoor decoration by turning the fan off.

14. The method of claim 12, wherein the sensor comprises a wind speed sensor, wherein the threshold is a wind speed threshold, and wherein the method comprises:
using the input from the wind speed sensor to determine that the wind speed threshold is met; and
responsive to determining that the wind speed threshold is met, controlling the fan to deflate the inflatable outdoor decoration.

15. The method of claim 12, wherein the sensor comprises a motion sensor, wherein the threshold is a movement threshold, and wherein the method comprises:
using the input from the motion sensor to determine that the movement threshold is met; and
responsive to determining that the movement threshold is met, controlling the fan to deflate the inflatable outdoor decoration.

16. An apparatus, comprising:
at least one computer readable storage medium (CRSM) that is not a transitory signal, the at least one CRSM comprising instructions executable by a processor system to:
receive input from a sensor;
use the input from the sensor to determine that a threshold is met; and
responsive to determining that the threshold is met, control a fan to deflate an inflatable outdoor decoration.

17. The apparatus of claim 16, wherein the sensor comprises a wind speed sensor, wherein the threshold is a wind speed threshold, and wherein the instructions are executable to:
use the input from the wind speed sensor to determine that the wind speed threshold is met; and
responsive to determining that the wind speed threshold is met, control the fan to deflate the inflatable outdoor decoration.

18. The apparatus of claim 16, wherein the sensor comprises a motion sensor, wherein the threshold is a movement threshold, and wherein the instructions are executable to:
use the input from the motion sensor to determine that the movement threshold is met; and
responsive to determining that the movement threshold is met, control the fan to deflate the inflatable outdoor decoration.

19. The apparatus of claim 16, comprising the processor system.

20. The apparatus of claim 19, comprising the sensor.
